(19) United States
(12) Patent Application Publication
(10) Pub. No.: US 2008/0047102 A1
(43) Pub. Date: Feb. 28, 2008

(54) FREE STOP HINGE DEVICE FOR PORTABLE TERMINAL

(75) Inventor: Young-Hun KIM, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/844,140

(22) Filed: Aug. 23, 2007

(30) Foreign Application Priority Data
Aug. 23, 2006 (KR) 80132/2006

(51) Int. Cl. E05D 11/10; E05C 17/64

(52) U.S. Cl. 16/303; 16/322; 16/337

(57) ABSTRACT

Disclosed is a free stop hinge device of a portable terminal. The free stop hinge device of a portable terminal including a first housing and a second housing, which are rotated about a hinge axis provided by the free stop hinge device so that the first housing and the second housing are folded to or unfolded from each other, includes a hinge housing, elastic bodies disposed in the hinge housing for providing driving force in a direction perpendicular to the hinge axis, and stopping unit subjected to the driving force and performing a cam operation along with the hinge housing for stopping the second housing at a desired angle with respect to the first housing.

### PRIORITY

This application claims priority to an application filed with the Korean Intellectual Property Office on Aug. 23, 2006 and assigned Serial No. 2006-80132, the contents of which are incorporated herein by reference.

### BACKGROUND OF THE INVENTION

1. Field of the Invention

The present invention relates to a portable terminal including Digital Multimedia Broadcasting phones (DMB phones), game phones, chatting phones, camera phones, MP3 phones, cellular phones, Personal Communication System phones (PCS phones), Personal Digital Assistants (PDAs) and Hand Held Phones (HHP phones), and more particularly to a free stop hinge device for a portable terminal, by which a user can position a display unit at a desired angle according to his/her preference.

2. Description of the Related Art

In general, the term “portable terminal” refers to an electronic device that a user can carry with him/her while communicating with another user wirelessly. The portable terminal can perform wireless communication, for example a voice communication, a message transmission, a file transmission, and an image communication, as well as taking a picture. In addition, the portable terminal plays the role of a personal assistant to manage phone numbers and personal schedules.

On the other hand, in consideration of portability, the design of portable terminals has tended not only toward being compact, slim and lightweight, but also toward providing multimedia capabilities to allow the user to pursue a wider variety of functions such as, for example, entertainment contents including games. In particular, future portable terminals will not only be multi-functional while still being compact and lightweight, but will also be modified to be suitable for functioning in a multimedia environment including image communication, games, Internet access, and camera functions, as well as for merely carrying out voice communication.

Conventional portable terminals may be classified into various types according to their appearance, such as bar-type portable terminals and folder-type portable terminals. The bar-type portable terminal has a single housing shaped like a bar, in which data input/output units, antenna, a transmitter, and a receiver, etc. are disposed. The folder-type portable terminal has a folder coupled to a single bar-shaped housing by a hinge unit in such a manner that the folder can rotate so as to be folded on or unfolded from the housing. Since the folder-type portable terminal includes a body on which keys are arranged, and a folder on which a display unit is arranged, there is an advantage in miniaturizing the terminal and improving the portability of the terminal.

A folder-type portable terminal is disclosed in U.S. Pat. No. 6,865,406. The folder-type portable terminal disclosed in U.S. Pat. No. 6,865,406 has a structure in which a camera-lens housing is mounted on a hinge device of the terminal.

Further, the description of a hinge device used for the flip or folder-type portable terminal is disclosed in detail in U.S. Pat. No. 6,292,980 which is commonly assigned to the assignee of the present application. The hinge device can semi-automatically open and close a folder with respect to a body.

However, the hinge device disclosed in U.S. Pat. No. 6,292,980 does not allow a user to position a display unit at an angle which he/she desires. Specifically, since the conventional hinge device has a predetermined open angle, the user cannot position the folder at the angle which he/she wants. Accordingly, it is inconvenient to view a screen displayed on the display unit. Actually, the incline angle of the display unit may vary depending on the user's desires or attitudes.

### SUMMARY OF THE INVENTION

Accordingly, the present invention has been made to solve the above-mentioned problems occurring in the prior art, and it is an aspect of the present invention to provide a free stop hinge device for a portable terminal, by which a display unit can be stopped at a desired rotation angle.

It is another aspect of the present invention to provide a free stop hinge device for a portable terminal, by which a display unit is inclined at a desired rotation angle in moving picture watching modes, for example, a DMB mode, a TV mode, and a game mode, thereby allowing a user to watch moving pictures with convenience.

In order to accomplish these aspects s of the present invention, according to an embodiment of the present invention, there is provided a free stop hinge device of a portable terminal including a first housing and a second housing, which are rotated about a hinge axis provided by the free stop hinge device so that the first housing and the second housing are folded to or unfolded from each other, the free stop hinge device including a hinge housing; elastic bodies disposed in the hinge housing for providing driving force in a direction perpendicular to the hinge axis; and stopping unit subjected to the driving force and performing a cam operation along with the hinge housing for stopping the second housing at a desired angle with respect to the first housing.

In order to accomplish these aspects of the present invention, there is provided a free stop hinge device of a portable terminal including a first housing and a second housing, which are folded to or unfolded from each other about a hinge axis provided by the hinge device, the free stop hinge device including a main hinge housing; a cam hinge housing received in the main hinge housing while facing an inner surface of the main hinge housing, and rotating along with the second housing; elastic bodies mounted in the cam hinge housing for providing driving force in a direction perpendicular to the hinge axis; and stopping unit mounted in the cam hinge housing, assembled with the elastic bodies, and always making contact with the inner surface of the main hinge housing to perform the cam operation and provide repulsion force, so as to stop the second housing at a desired angle.

### BRIEF DESCRIPTION OF THE DRAWINGS

The above and other objects, features, and advantages of the present invention will be more apparent from the following detailed description taken in conjunction with the accompanying drawings, in which:

FIG. 1 is a perspective view showing a portable terminal employing a free stop hinge device according to the present invention;

FIG. 2 is a perspective view showing the portable terminal employing the free stop hinge device according to the present invention, in which the second housing of the portable terminal is open;

FIG. 3 is a perspective view showing the free stop hinge device according to the present invention, in which the hinge device is installed in the first housing;

FIG. 4 is an exploded perspective view showing the free stop hinge device according to the present invention;

FIG. 5 is a perspective view showing the free stop hinge device according to the present invention;

FIG. 6 is a side view showing a hinge housing of the free stop hinge device according to the present invention;

FIG. 7 is a sectional view showing a stopper housing of the free stop hinge device according to the present invention;

FIG. 8 is a perspective view showing a stopper of the free stop hinge device according to the present invention, in which elastic members are assembled with the stopper;

FIG. 9A is a side view showing the free stop hinge device before a cam operates; and

FIG. 9B is a side views showing the free stop hinge device after the cam operates.

### DETAILED DESCRIPTION OF THE PREFERRED EMBODIMENT

Hereinafter, the preferred embodiment of the present invention will be described in detail with reference to the accompanying drawings. In the following description of the present invention, a detailed description of known functions and configurations incorporated herein is omitted for clarity and conciseness.

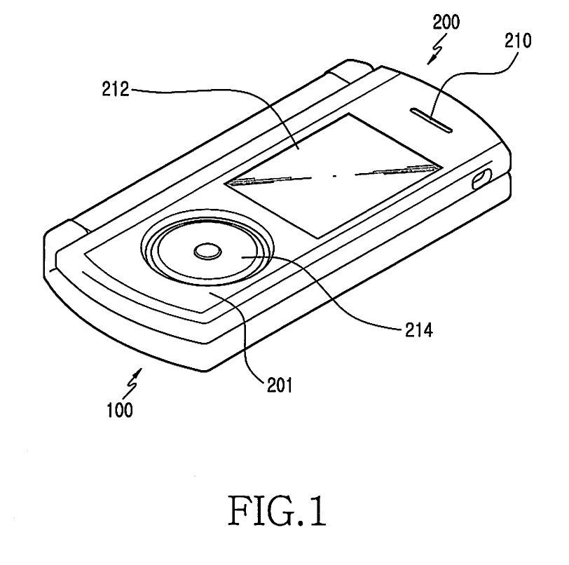

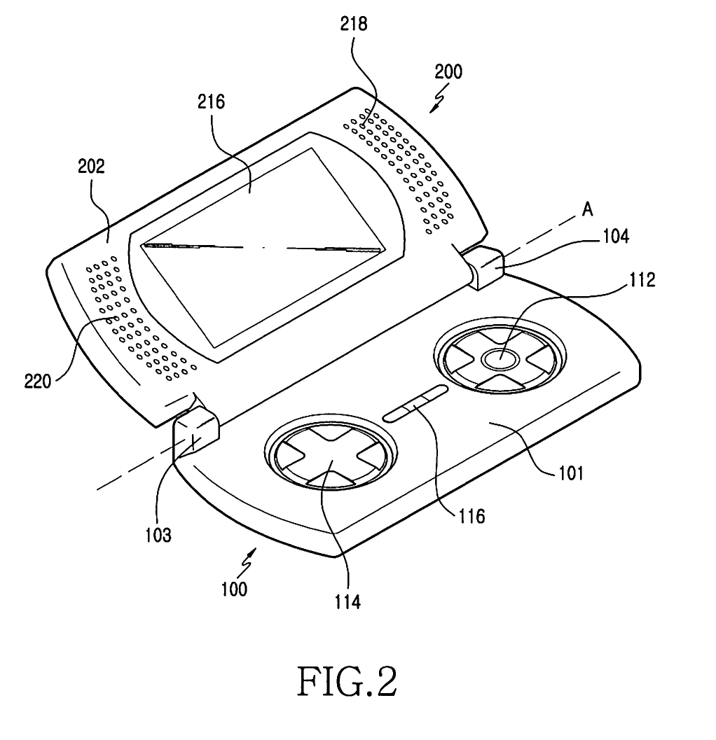

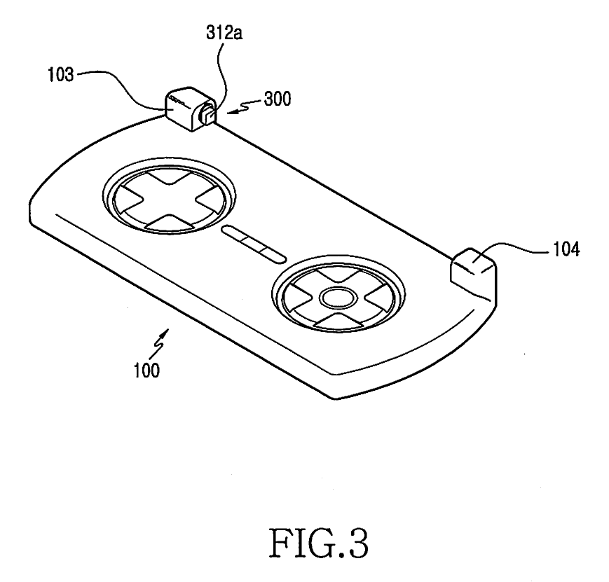

FIGS. 1 and 2 are views showing a portable terminal employing a free stop hinge device according to the present invention. FIG. 1 shows the closed portable terminal, and FIG. 2 shows the open portable terminal. The portable terminal shown in FIGS. 1 and 2 is a folder-type, through which a user can conveniently use a communication function in DMB, navigation, and game modes. The portable terminal includes a first housing 100, a second housing 200 folded or unfolded with respect to the first housing 100, and a free stop hinge device 300 opening and closing the second housing 200 about a hinge axis A with relation to the first housing 100 (see FIG. 3). The hinge axis A extends in a longitudinal direction of the first and second housing 100 and 200. FIG. 1 shows the portable terminal used in a phone mode, and FIG. 2 shows the portable terminal used in a DMB mode, a TV mode, a navigation mode, or a game mode.

As shown in FIGS. 1 and 2, the first housing 100 has first keys 112, 114 and 116 arranged thereon. The second housing 200 has a speaker, a first display unit 212, and second keys 214 arranged on an exterior surface 201 thereof, and a second display unit 216 and second speakers 218 and 220 arranged on an inner surface 202 thereof. The first keys include four-way keys 112 and 114 in order to select channels or operate games. Particularly, two four-way keys 112 and 114 are arranged side by side, so that the user can operate keys conveniently with both hands. The first display unit 212 displays lots of information relating to the phone mode, and the second display unit 216 displays various moving pictures. Further, the first speaker 210 is a single speaker relating to the phone mode, and the second speakers 218 and 220 are constituted in pair so as to provide stereo sound with respect to the various moving pictures, and thereby allow the user to watch the moving pictures conveniently. The first display unit 212 is always exposed to the user, and the second display unit 216 is exposed to the user when the second housing 200 is open. The second display unit 216 has a width wider than its height, so as to make it possible for a user to watch various moving pictures conveniently in a landscape mode. The first and second displays 212 and 216 may include a liquid crystal display unit or a touch screen.

FIG. 3 is a perspective view showing a free stop hinge device mounted on the first housing 100, in which the second housing 200 is separated from the first housing 200. Referring to FIG. 3, the free stop hinge device 300 according to the present invention is mounted on one side hinge arm 103 of the first housing 100. A hinge dummy, not shown, is mounted on the other side hinge arm 104.

In the free stop hinge device 300, only a coupling shaft 312a is exposed to the outside, and other portions are hidden in the side hinge arm 103. In addition, the coupling shaft 312a is assembled with the second housing 200, so as to mechanically couple the first and second housings 100 and 200 with each other.

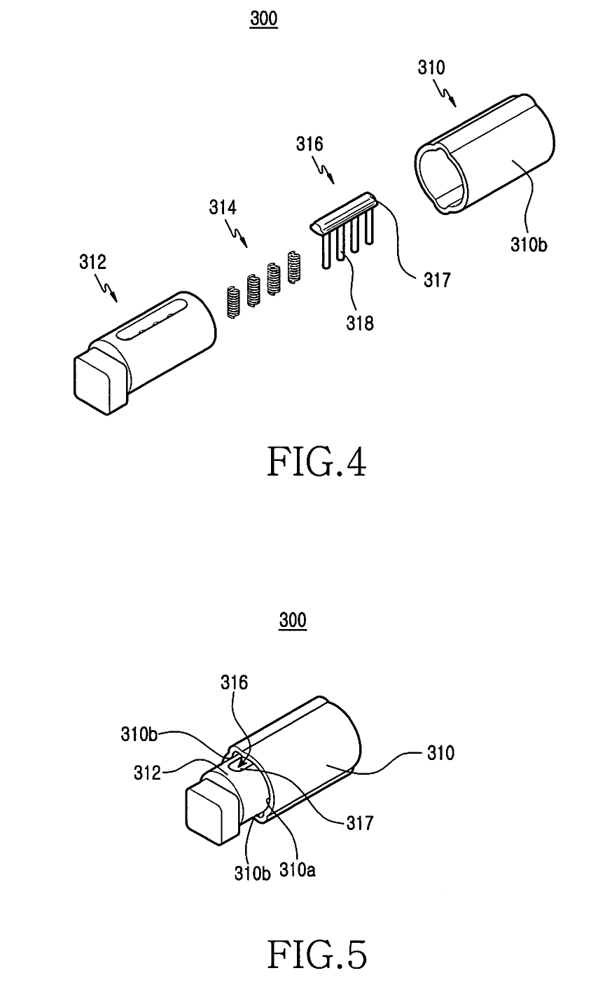

Hereinafter, the configuration of the free stop hinge device according to the present invention will be described in detail with reference to FIGS. 4 to 8.

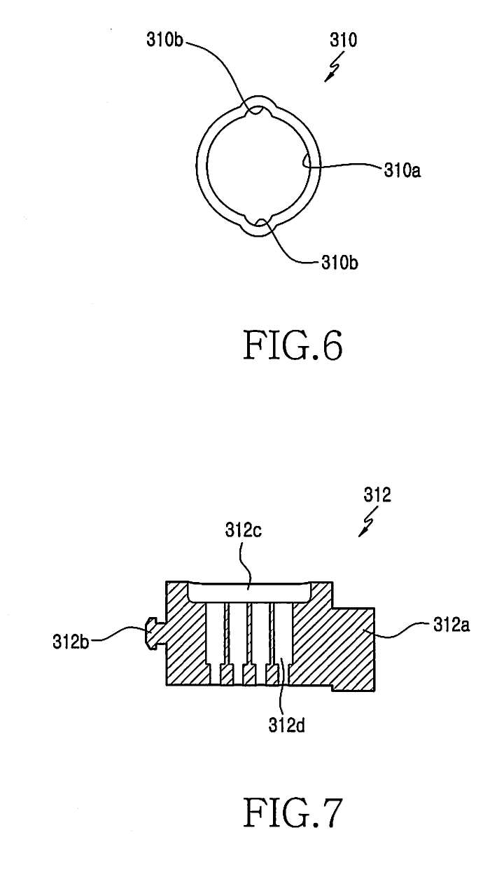

As shown in FIGS. 4 and 5, the hinge device 300 according to the present invention includes hinge housings 310 and 312, elastic bodies received in the hinge housings 310 and 312 for providing driving force, and stopping unit received in the hinge housings 310 and 312 having the elastic bodies for stopping the second housing 200. The two hinge housings are provided to the hinge device 300, and include a main hinge housing 310 arranged on the exterior of the hinge device 300 and a cam hinge housing 312 arranged in the hinge device 300. The cam hinge housing 312 is inserted into the main hinge housing 310 in a longitudinal direction and assembled with the main hinge housing 310. Further, the main hinge housing 310 may be integrally formed on an inner surface of the side hinge arm 103 by a manner of injection molding (see FIG. 3). The cam hinge housing 312 is assembled with the main hinge housing 310 in a direction of a hinge axis, and received in the side hinge arm 103 to provide driving force in a direction perpendicular to the hinge axis A (see FIG. 6).

The elastic bodies 314 include at least one compressed coil spring that is installed perpendicularly to the longitudinal direction of the main hinge housing 312. Further, four elastic bodies 314 are mounted on the guides 318 of the stopper 316 described below and provide repulsive force with relation to the inner surface of the main hinge housing 310, so as to provide force to stop the second housing 200.

The stopping unit is subjected to driving force provided by the elastic bodies 314 so as to perform a cam operation in the main hinge housing 310. As a result, the stopping unit stops the rotation of the second housing 200 at a desired angle with respect to the first housing 100.

As shown in FIGS. 4 and 5, the stopping unit includes an inner surface 310a of the main hinge housing and a stopper 316 rotating while facing the inner surface 310a of the main hinge housing. The stopping unit is subjected to force applied to the inner surface 310a by the elastic bodies 314, provides repulsive force maintaining the contact of the stopper with the inner surface 310a, and supplies stopping force to the second housing depending on the repulsive force.

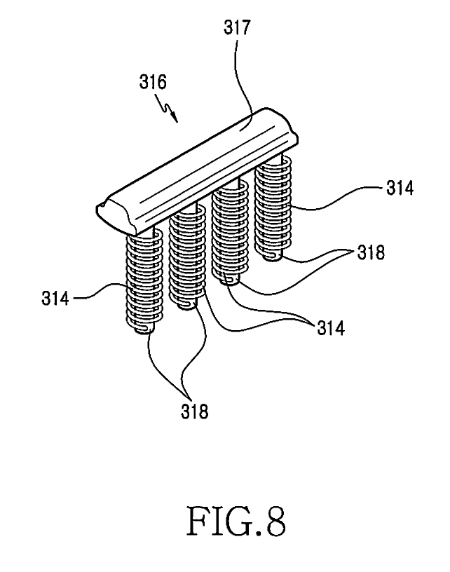

As shown in FIGS. 4 and 8, the stopper 316 includes a cam portion 317 extending in a direction parallel with the hinge axis, and at least one guide 318 extending perpendicularly to the cam portion 317 and moving vertically in the cam hinge housing 312 while being having the elastic bodies 314 received therein. The cam portion 317 has a cam surface on an upper surface thereof, and performs the cam operation while contacting with the inner surface 310a of the main hinge housing 310. Further, the cam portion 317 extends a desired length in a direction parallel with the hinge axis while protruding toward the inner surface 310a, and moves perpendicularly to the hinge axis. The guide 318 has a post shape, and extends perpendicularly to the cam portion 317 through the elastic bodies 314. FIG. 4 shows four guides 318.

As shown in FIGS. 4 and 6, the inner surface 310a of the main hinge housing 310 is provided with at least one groove 310b extending parallel with the hinge axis. The grooves 310b are engaged with the cam portion 317 of the stopper of the stopping unit so as to provide stopping force. Of course, the stopping force is provided to the second housing when the cam portion 317 comes into contact with the inner surface 310a or groove 310b. However, when the stopping unit is received in the groove 310b, it is possible to easily and stably stop the main hinge housing 310. Further, at least two grooves 310b are formed along an inner peripheral surface of the main hinge housing 310. In FIGS. 4 and 6, two grooves 310b are formed. In addition, the grooves 310b are formed to protrude on the outer periphery of the main hinge housing 310.

As shown in FIG. 7, the elastic bodies 314 and the stopper 316 are stably installed in the cam hinge housing 312 having a space corresponding to the combination of the elastic bodies 314 and the stopper 316. In particular, the cam hinge housing 312 includes the first opening 312c with an open upper end and receiving the cam portion 317 of the stopper, and at least one second opening 312d being communicated with the first opening 312c and receiving the elastic bodies 314. The second opening 312d is a space to receive the elastic bodies 314 mounted perpendicularly to the lengthwise direction of the cam hinge housing 312, which has a post shape and extends perpendicularly. Further, the first opening 312c has opened upward, in which the elastic bodies 314 and the stopper 316 are inserted and assembled with each other. When the elastic bodies 314 and the stopper 316 are assembled in the first and second openings 312c and 312d, the stopper 316 is always subjected to elasticity, so as to move toward the inner surface of the main hinge housing. This is because each elastic body 314 is mounted in such a manner that the one end thereof makes contact with the inner surface of a step portion of the second opening 312d of the cam hinge housing, and the other end thereof comes into contact with the cap portion 317. Accordingly, the elastic bodies 314 always urge the stopper 317 outward so that the stopper 317 is away from the cam hinge housing 312.

Further, the cam hinge housing 312 includes a coupling shaft 312a formed on one end thereof coupled with the second housing 200, and a fixed shaft 312b formed on the other end thereof and facing the coupling shaft 312a while being fixed to the first housing 100 by means of a coupling element. The coupling shaft 312a has a box shape, and is eccentrically formed on one end of the cam hinge housing 312 to be parallel with the hinge axis. Further, the coupling shaft 312a is integrally formed on the cam hinge housing 312 in a manner of an injection molding, and rotates along with the second housing 200. In addition, the coupling element 318 may be an E-ring (FIG. 8).

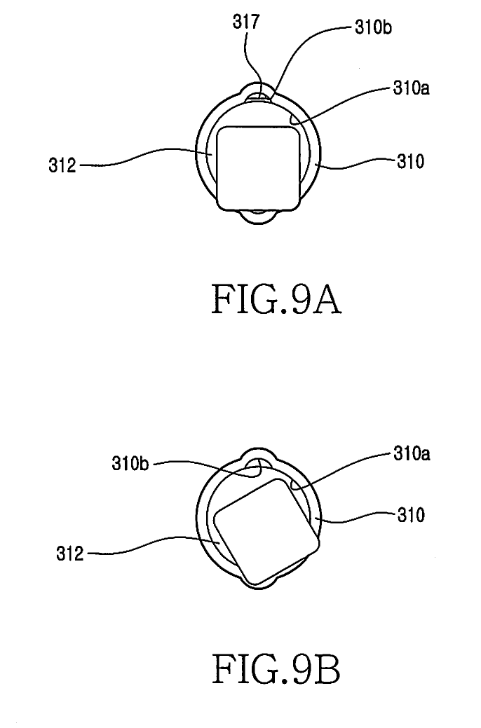

Hereinafter, the cam operation of the free stop hinge device according to the present invention will be described with reference to FIGS. 9A and 9B. As shown in FIG. 9A, assuming that the user rotates the second housing to an angle of about 100 degrees, the cam portion 317 slides and descends in the groove 310b, resulting in deviation from the groove 310b, and then always makes contact with and slides on the inner surface 310a of the main hinge housing. As shown in FIG. 9B, when the user forcibly removes the rotation force of the second housing, the cam surface of the cam portion 317 makes contact with and resists the inner surface 310a, so as to stop the rotation of the second housing. Of course, the cam portion 317 escapes from the groove 310b and moves downward. The elastic bodies enable the cam portion 317 to make close contact with the inner surface 310. Repulsion force, such as friction force, is generated between the cam portion 317 and the inner surface 310a, and thereby the second housing 200 can be stopped at an angle that a user desires, with respect to the first housing 100, as shown in FIG. 2. Then, when the second display unit 216 mounted on the second housing is cradled and inclined, and stereo sound is provided through both speaker units 218 and 220, the user can conveniently watch the various moving pictures. As described above, the portable terminal shown in FIG. 1 can be used in the phone mode, and the portable terminal shown in FIG. 2 can be used in a game mode, DMB mode, navigation mode, etc.

As described above, since the present invention has a structure in which the display unit can be stopped at the desired angle, the display unit can be inclined at the desired rotation angle in mode, such as DMB mode, TV mode, and game mode, relating to watching of various moving pictures and stereo sound can be provided. Accordingly, it is possible for a user to watch the moving pictures conveniently.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A free stop hinge device of a portable terminal including a first housing and a second housing rotatably connected to the first housing by the free stop hinge device, the free stop hinge device comprising:
a hinge housing;
elastic bodies disposed in the hinge housing for providing a driving force in a direction perpendicular to a hinge axis of the free stop hinge device; and
stopping unit subjected to the driving force and performing a cam operation along with the hinge housing for stopping the second housing at a desired angle with respect to the first housing.

2. The free stop hinge device as claimed in claim 1, wherein the elastic bodies include at least one compressed coil spring.

3. The free stop hinge device as claimed in claim 2, wherein the at least one compressed coil spring is mounted in the hinge housing in a direction perpendicular to a length of the hinge housing.

4. The free stop hinge device as claimed in claim 1, wherein the stopping unit includes an inner surface of the hinge housing, and a stopper rotating while facing the inner surface, the stopper being subjected to the driving force to maintain a close contact with the inner surface to provide a stopping force to the second housing.

5. The free stop hinge device as claimed in claim 4, wherein the stopper includes a cam portion extending parallel to the hinge axis, and guides extending from the cam portion perpendicular to the hinge axis and having the elastic bodies mounted on the guides one by one, the guides reciprocating in the hinge housing.

6. The free stop hinge device as claimed in claim 5, wherein an upper surface of the cam portion includes a cam surface and always makes close contact with the inner surface to perform a cam operation, and the guides are posts extending through the elastic bodies one by one.

7. A free stop hinge device of a portable terminal including a first housing and a second housing rotatably connected to the first housing by the hinge device, the free stop hinge device comprising:
a main hinge housing;
a cam hinge housing received in the main hinge housing while facing an inner surface of the main hinge housing, and rotating along with the second housing;
elastic bodies mounted in the cam hinge housing for providing a driving force in a direction perpendicular to a hinge axis of the free stop hinge device; and
stopping unit mounted in the cam hinge housing, assembled with the elastic bodies, and always making a close contact with the inner surface of the main hinge housing to perform a cam operation and provide a repulsion force to stop the second housing at a desired angle.

8. The free stop hinge device as claimed in claim 7, wherein the stopping unit includes the inner surface of the main hinge housing and a stopper received in the cam hinge housing and subjected to the driving force to make the close contact, the stopper always maintaining the close contact to provide the repulsion force.

9. The free stop hinge device as claimed in claim 8, wherein the stopper includes a cam portion extending parallel to the hinge axis and protruding toward the inner surface to move perpendicular to the hinge axis, and at least one guide extending through the elastic bodies and perpendicular to the hinge axis.

10. The free stop hinge device as claimed in claim 7, wherein the main hinge housing further has at least one groove which extends parallel to the hinge axis, is on the inner surface and is engaged with the stopping unit.

11. The free stop hinge device as claimed in claim 7, wherein the cam hinge housing includes a first opening receiving the stopping unit, an upper end of the first opening is open, and at least one second opening communicating with the first opening and receiving the elastic bodies.

12. The free stop hinge device as claimed in claim 7, wherein the cam hinge housing further includes a coupling shaft formed at one end of the cam hinge housing, coupled with and rotating along the second housing, and a fixing shaft fixed to the first housing by coupling elements.

13. The free stop hinge device as claimed in claim 12, wherein the coupling shaft has a box shape and is eccentrically formed on an end of the cam hinge housing so that an axis of the coupling shaft is parallel to the hinge axis.

14. The free stop hinge device as claimed in claim 12, wherein the coupling shaft is integrally formed on the cam hinge housing by injection molding.
